(19) United States
(12) Patent Application Publication
(10) Pub. No.: US 2026/0205359 A1
(43) Pub. Date: Jul. 16, 2026

(54) UNIFORM POLICY STORAGE AND DISTRIBUTION

(71) Applicant: Boost SubscriberCo L.L.C., Englewood, CO (US)

(72) Inventors: Siddhartha Chenumolu, Ashburn, VA (US); Dhaval Mehta, Aldie, VA (US)

(21) Appl. No.: 19/020,788

(22) Filed: Jan. 14, 2025

(51) Int. Cl. H04L 41/0894; H04L 9/40; H04L 41/0896

(52) U.S. Cl. CPC H04L 41/0894; H04L 41/0896; H04L 63/08; H04L 63/107

(57) ABSTRACT

A method of providing network services by a network provider may include receiving, by a uniform policy module of a network provider, a user policy for providing network services to a user device. The method may include generating, by the uniform policy module, one or more network parameters associated with the user device and based at least in part on the user policy. The method may include receiving, by the uniform policy module, a request from a network access controller associated with the network provider to provide network services to the user device. The method may include transmitting, by the uniform policy module, at least some of one or more network parameters to the network access controller, such that the network access controller provides the network services to the user device according to the transmitted network parameters such that the request is fulfilled.

### BACKGROUND

A network provider may have many users (and user devices) that must adhere to one or more policies from administrators of varying levels. Furthermore, these policies may differ from one region to the next, based on network type, or any other such variable. The network provider may not be aware of all policies for all users at all times. Likewise, the administrators may not be aware of which network components and where a user may go. Thus, a system for efficiently deploying policies for a network provider is needed.

### BRIEF SUMMARY

A method of providing network services by a network provider may include receiving, by a uniform policy module of a network provider, a user policy for providing network services to a user device. The method may include generating, by the uniform policy module, one or more network parameters associated with the user device and based at least in part on the user policy. The method may include receiving, by the uniform policy module, a request from a network access controller associated with the network provider to provide network services to the user device. The method may include transmitting, by the uniform policy module, at least some of one or more network parameters to the network access controller, such that the network access controller provides the network services to the user device according to the transmitted network parameters such that the request is fulfilled.

In some embodiments, the one or more network parameters may include a bandwidth allocation indicating an amount of bandwidth allocated to the user device. The one or more network parameters may include quality of service (qos) parameters indicating priority levels for different types of traffic transmitted to and from the user device. The one or more network parameters may include access control parameters indicating authentication requirements for providing the network services to the user device. In response to receiving the access control parameters, the network access controller may verify that the authentication requirements are satisfied before providing the network services to the user device. The one or more network parameters may include security parameters indicating encryption protocols and security measures to be applied to data transmitted to and from the user device. The uniform policy module may be accessible by a plurality of network access controllers. The request to provide network services to the user device may be generated by the network access controller in response to receiving a registration request from the user device via an access point managed by the network access controller. A first set of the one or more network parameters may be associated with a first location, and a second set of the one or more network parameters may be associated with a second location. The user policy and/or the one or more network parameters may be stored in a policy database.

A system for providing network services may include one or more processors and a computer readable memory including instructions that, when executed by the one or more processors, cause the one or more processors to perform operations. According to the instruction, the system may receive, by a uniform policy module of a network provider, a user policy may include one or more rules for providing network services to a user. The system may generate, by the uniform policy module, one or more network parameters associated with a user device based at least in part on the user policy. The system may receive, by the uniform policy module, a request from a network access controller associated with the provide network services to the user device associated with the user. The system may transmit, by the uniform policy module, at least some of one or more network parameters to the network access controller, such that the network access controller provides the network services to the user device associated with the user according to the transmitted network parameters.

A non-transitory computer-readable memory may include instructions that, when executed by one or more processors, cause the one or more processors to perform operations. The operations may include receiving, by a uniform policy module of a network provider, a user policy for providing network services to a user device. The operations may include generating, by the uniform policy module, one or more network parameters associated with the user device and based at least in part on the user policy. The operations may include receiving, by the uniform policy module, a request from a network access controller associated with the network provider to provide network services to the user device. The operations may include transmitting, by the uniform policy module, at least some of one or more network parameters to the network access controller, such that the network access controller provides the network services to the user device according to the transmitted network parameters such that the request is fulfilled.

### BRIEF DESCRIPTION OF THE DRAWINGS

FIG. 1 illustrates a system and a process for providing network services to a user equipment 108, according to certain embodiments.

FIG. 2A illustrates a system for generating network parameters to provide network services to a UE, according to certain embodiments.

FIG. 2B illustrates a system providing network services to a user equipment, according to certain embodiments.

FIG. 2C illustrates a uniform policy manager generating first network parameters, according to certain embodiments.

FIG. 2D illustrates a system providing network services to the user equipment, according to some embodiments.

FIG. 3 illustrates a flowchart of a method for providing uniform policy storage and distribution, according to certain embodiments.

FIG. 4A illustrates an embodiment of a cellular network system, according to certain embodiments.

FIG. 4B illustrates an exemplary core, according to certain embodiments.

FIG. 5 illustrates an embodiment of a cellular network core network topology as implemented on a public cloud-computing platform, according to certain embodiments.

### DETAILED DESCRIPTION

An organization may include multiple users, where some or all of the users may access a wireless network. For example, the organization may provide cellular services for the users, provide internet access (e.g., via a wireless local area network (WLAN) or other such network), provide access certain content to the users, etc. In some cases, the organization may provide these services itself. In other cases, the organization may provide some or all of these services via a network provider.

In many organizations, the users may have varying access levels to some or all of the services. For example, a first user may be permitted to use a given amount of data on a 5G wireless network associated with the organization (e.g., via an account with a network provider administered by the organization). A second user may be permitted to use a different amount of data on the 5G network. Other examples may include changes to a quality of service (QoS), priority levels, access to certain files, internet sites, etc., encryption protocols (e.g., for call data, protected files, etc.), and/or other aspects of network access. To manage the varying service levels of the various users, the organization may provide a user policy associated with each of the users. The user policies may define various rules, network parameters etc. governing access to the network and/or other services for each user. The user policies may additionally or alternatively include different policies for different user equipments associated with the user (e.g., a laptop and a mobile device associated with the same user).

Generally, a user may be relatively stationary, meaning that the majority of the user’s access to the network services may occur from the same location (e.g., the same building, neighborhood, region, city, etc.). The user policies governing the user may therefore be provided to one or more network access controllers (NACs) of the network provider such that the user has the appropriate service levels within the location. Examples of NACs may include Access and Mobility Functions (AMFs), Policy Control Functions (PCFs), WLAN controllers (WLCs), and any other such network function and/or access controller. However, if the user accesses the network services from a different location, the access provided to the user may be different than that provided at the first location. Because NACs may be regionally based (e.g., different network cores for different regions), the NACs associated with the second location may not have access to the appropriate user policies. Thus, the relevant NACs may not “know” what service levels the user should receive.

Because the user policies may be set by the organization and not the network provider, the network provider may not automatically have access to the user policies for each location the user might visit. In other words, the organization may be required to provide user policies for each location before the network provider is able to provide the appropriate service levels. The organization may therefore individually provide user policies for each user to each NAC for each location. However, having user policies transmitted and stored to each NAC may be computationally inefficient, both in processing and storage. Additionally, keeping unused (or rarely used) user policies stored on various NACs may present security risks.

Another solution may be for the organization to provide user policies to each NAC when appropriate. For example, the user may be based in Denver and be travelling to Atlanta. Then, the user may notify the organization (e.g., an admin) and the organization may provide the appropriate user policies to the network provider, who may then modify the NAC(s) as needed. This process may be slow and require the involvement of several parties to provide the correct services to the user. Any breakdown in the chain may result in the user not being provided the correct services. Thus, systems and techniques for providing user policies to NACs is needed in order to efficiently provide network services to the user.

One solution may be for a network provider to provide universal policy module. The universal policy module may be a module configured to receive user policies from one or more organizations and provide the user policies to one or more NACs of the network provider. The organization may provide user policies defining network services for a user associated with the organization to the universal policy module via an application programming interface (API), web portal, or other such means. The user policies may include different policies for different geographic regions, different user equipments associated with the user, and/or various rules governing network services or access for the user.

Then, a NAC of the network provider may receive a request for network services from a user equipment. The request may include a device identifier. Then, the NAC may transmit some or all of the request to the universal policy module (UPM). The UPM may then utilize the device ID to determine whether or not the UPM has a user policy associated with the user equipment (i.e., the user of the user equipment). Assuming that the UPM includes the relevant user policy, the UPM may parse the user policy in order to determine network parameters in order to provide the user equipment with the appropriate network services. The UPM may then transmit some or all of the network parameters to the NAC. The NAC may then modify one or more network functions, QoS priorities, etc. in order to adhere to the user policies. The network provider (via the NAC) may then provide network services to the user equipment.

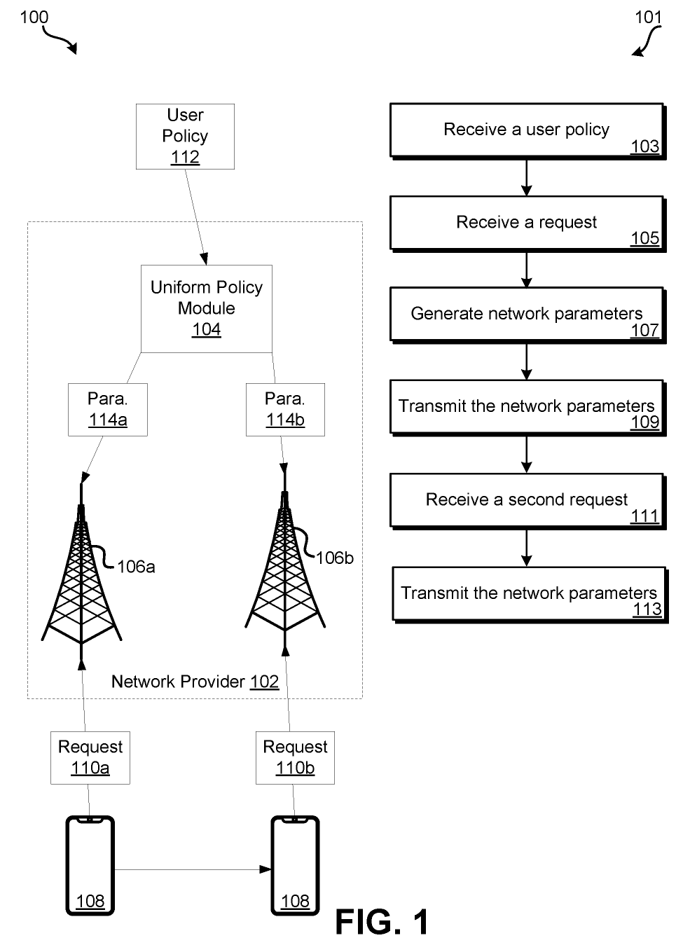

FIG. 1 Illustrates a system 100 and a process 101 for providing network services to a user equipment 108, according to certain embodiments. The system 100 may include a network provider 102 with a uniform policy module (UPM) 104 and a first network access controller (NAC) 106a and a second NAC 106b. The system 100 may also include the user equipment 108. The network provider 102 may be a wireless network provider that provider cellular service, data services, internet access, wireless access point(s), and or other network services. The wireless network provider 102 may therefore include one or more physical and/or virtual computers that are configured to operate in concert in order to provide some or all of the functionality described herein. For example, the network provider 102 may provide a 5G cellular network. The 5G cellular network may be a standalone 5G network or may be a hybrid network including 3G, 4G, 6G, and/or 7G components. Some or all of the 5G network may be implemented using a distributed, cloud-based network.

The UPM 104 may be one or more hardware and/or software components implemented in a centralized location, such that various elements of the network provider 102 may access the UPM 104. The UPM 104 may additionally be configured to receive one or more user policies from various organizations. Thus, the UPM 104 may include an associated API, web portal, or other such means for receiving user policies. The UPM 104 may include a database for storing user policies, and/or logic for sorting the entries within the database. The UPM 104 may also include functionality to parse a user policy in order to generate instructions to alter at least one network function of the network provider 102.

The first and second NACs 106a-b may include one or more network function for providing network services to the user equipment 108. The first and second NACs 106a-b may include respective centralize units (CUs), distributed units (DUs), radio units (RUs), and any other components necessary for providing network services. For example, the first NAC 106a may include an RU, DU, and/or a CU used by the network provider 102 to provide a 5G cellular network in a first location. Additionally or alternatively, the first NAC 106a may include a WAP, WLC, or other type of NAC for providing a wireless network. Similarly, the second NAC 106b may include 5G cellular network components (hardware and/or software) and/or a NAC(s) to provide a wireless network in a second location. In some embodiments one or both of the first and second NACs 106a-b may be associated with the network provider 102 and/or a partner network provider.

The user equipment 108 may be a mobile phone, tablet, laptop, or other such device. The user equipment 108 may be associated with an organization (e.g., a university, company, etc.). A user of the user equipment 108 may be a member of the organization, and network services may be provided by the network provider 102 to the user equipment 108 through the organization. In other words, the organization (or an admin thereof) may manage wireless access through the network provider 102 for the user equipment 108.

At 103, the UPM 104 may receive a user policy 112 from the organization. The user policy 112 may indicate services and/or service levels to be provided to the user equipment 108 by the network provider 102. The user policy 112 may indicate a bandwidth allocation (e.g., an amount of cellular data), a data speed, authentication and authorization requirements (e.g., authenticating the user before granting network services), security parameters (e.g., data encryption protocols), and other such policies. The user policy 112 may also include various rules associated with the network services. For example, the user policy 112 may indicate a first data speed to be provided to the user equipment (UE) 108 at a first time (e.g., from 9am-5pm) and a second data speed to be provided at other times.

At 105, the first NAC 106a may receive a first connection request 110a from the UE 108. The first connection request 110a may include a device ID associated with the UE 108 and/or other identifying information. The first connection request 110 may also include data indicating service level requirements. The first NAC 106a may then use the identifying information and/or the service level requirements to determine whether the network provider 102 can provide adequate network services to the UE 108. For example, a network function (e.g., an Access and Mobility Function (AMF)) may determine that the network provider 102 is able to provide network services to the UE 108 via the first NAC 106a. The network function may then query the UPM 104 to determine whether there is a user policy applicable to the UE 108 at the first NAC 106a.

The UPM 104 may then determine that the user policy 112 may be applicable to the UE 108. For example, the UPM 104 may utilize the device ID to determine that the UE 108 is covered by the user policy 112. In some embodiments, the user policy 112 may only be applicable to the UE 108. In other embodiments, the user policy 112 may be applicable to multiple users associated with the organization.

At 107, the UPM 104 may generate first network parameters 114a used to configure one or more network functions (and/or other components) of the network provider 102 to provide network services to the UE 108. The first network parameters 114a may be generated, at least in part, by parsing the user policy 112. For example, the user policy 112 may include rules that govern which network services and/or service levels the UE 108 should receive. The UPM 104 may then generate the first network parameters 114a to include instructions based on the rules to be executed by a computing device to modify the one or more network functions.

At 109, the UPM 104 may transmit the first network parameters 114a to the first NAC 106a. The first NAC 106a (or components thereof) may then utilize the first network parameters 114a to modify functions and provide the network services. For example, the first network parameters 114a may include modifications to network functions such as a Policy Control Function (PCF), a Session Management Function (SMF), an AMF, modifications to a packet data unit (PDU) handling/priority (e.g., QoS modifications), and/or other such network functions. Additionally or alternatively, the first network parameters 114a may be used to cause network components such as WAPs, routers, switches, etc. to perform in a manner that adheres to the requirements of the organization (e.g., according to a service level agreement (SLA)). The network provider 102 may then provide the network services to the UE 108.

Subsequently, the UE 108 may move to a second location. The second location may be a different building, region, city, etc. The second location may be just leaving a building covered by the first NAC 106a. Thus, the UE 108 may attempt to receive network services from the second NAC 106b.

At 111, the second NAC 106b may receive a second connection request 110b from the UE 108. The second connection request 110b may include the device ID associated with the UE 108 and/or other identifying information. The second connection request 110b may also include data indicating service level requirements. The first NAC 106a may then use the identifying information and/or the service level requirements to determine whether the network provider 102 can provide adequate network services to the UE 108. For example, a network function (e.g., an AMF may determine that the network provider 102 is able to provide network services to the UE 108 via the second NAC 106b. The network function may then query the UPM 104 to determine whether there is a user policy applicable to the UE 108 at the second NAC 106b.

In some embodiments, the second NAC 106b may not be a component of the network provider 102. Instead, the second NAC 106b may be a component of a partner network provider, contracted to provide network services to clients of the network provider 102. For example, the network provider 102 may not have infrastructure to provide network services at the second location. The partner network provider may provide network services to the clients of the network provider 102 according to a partnership agreement etc. The organization, however, may not be a client of the partner network provider, and thus may not have direct access to user policies etc. Then, the partner network provider may transmit some or all of the second connection request 110b to the network provider 102 (e.g., through an AMF/SMF of the partner network provider). The network provider 102 may then query the UPM 104 to determine whether the UPM 104 includes a user policy governing the UE 108.

The UPM 104 may determine that the user policy 112 applies to the UE 108 at the second location (e.g., the second NAC 106b). The UPM 104 may then parse the rules of the user policy 112 to generate second network parameters 114b. The second network parameters 114b may be generated, at least in part, by parsing the user policy 112. For example, the user policy 112 may include rules that govern which network services and/or service levels the UE 108 should receive. The UPM 104 may then generate the second network parameters 114b to include instructions based on the rules to be executed by a computing device to modify the one or more network functions.

At 113, the UPM 104 may transmit the second network parameters 114b to the second NAC 106b. The second NAC 106b (or components thereof) may then utilize the second network parameters 114b to modify functions and provide the network services. For example, the second network parameters 114b may include modifications to network functions such as a PCF), a SMF, an AMF, modifications to PDU handling/priority (e.g., QoS modifications), and/or other such network functions. Additionally or alternatively, the second network parameters 114b may be used to cause network components such as WAPs, routers, switches, etc. to perform in a manner that adheres to the requirements of the organization (e.g., according to an SLA). The second NAC 106b may then provide the network services to the UE 108.

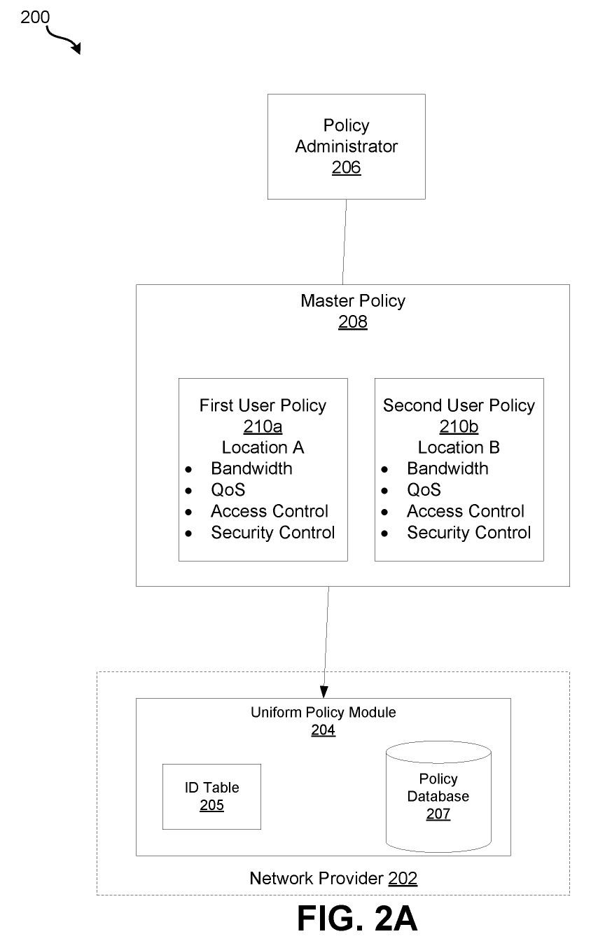

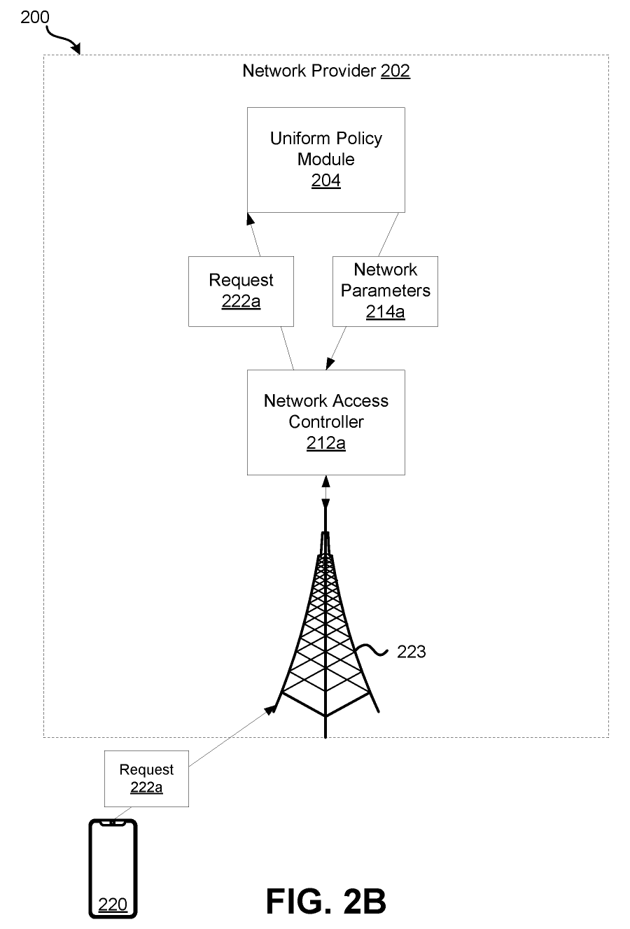

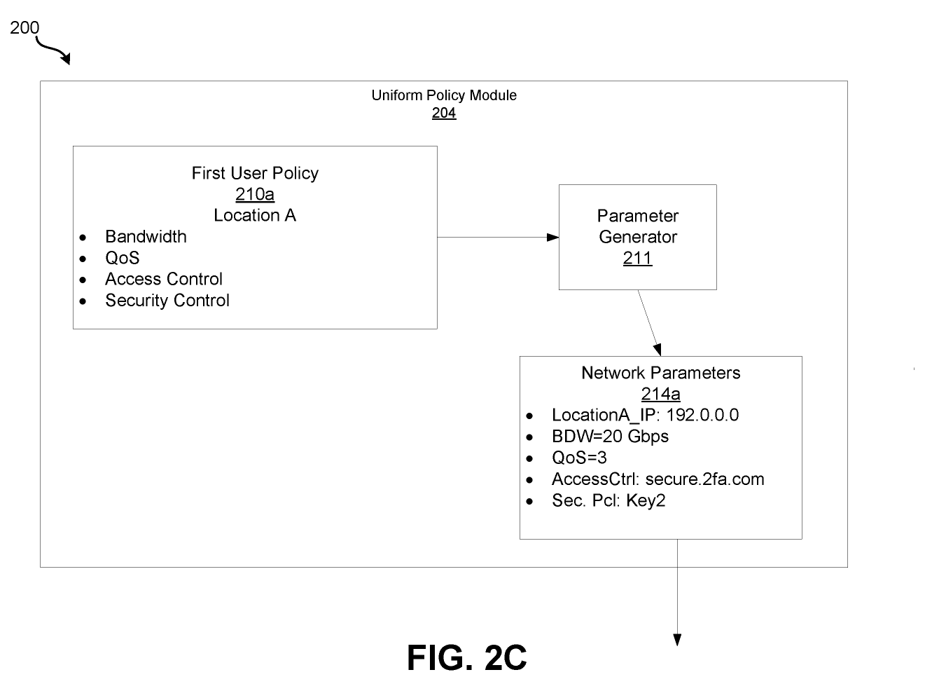

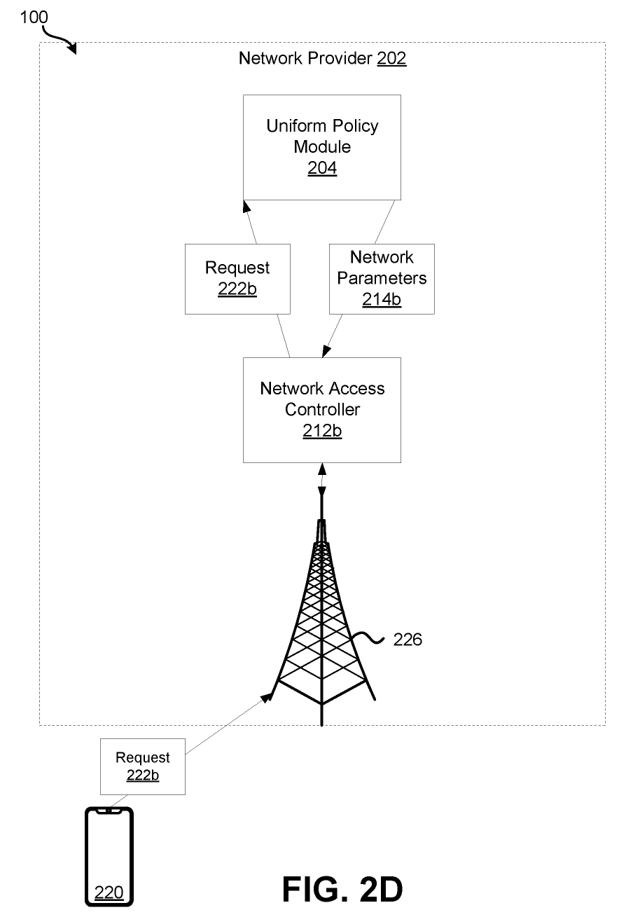

FIG. 2A illustrates a system 200 for generating network parameters to provide network services to a UE, according to certain embodiments. The system 200 may include a network provider 202 with a UPM 204. The UPM 204 may include an ID table 205 and a policy database 207. The network provider 202 may be similar to the network provider 102 in FIG. 1. The network provider 202 may be a wireless network provider that provider cellular service, data services, internet access, wireless access point(s), switches, routers, and or other network components. The wireless network provider 202 may therefore include one or more physical and/or virtual computers that are configured to operate in concert in order to provide some or all of the functionality described herein. For example, the network provider 202 may provide a 5G cellular network. The 5G cellular network may be a standalone 5G network or may be a hybrid network including 3G, 4G, 6G, and/or 7G components. Some or all of the 5G network may be implemented using a distributed, cloud-based network.

The ID table 205 may include data indicating various device IDs, user IDs, and/or other such identifying information. For example, a user may have an associated user ID. The user may also have one or more associated UEs, each with a unique device ID. Furthermore, a user policy governing network services for the user may include different rules, policies, etc. for each of the device IDs. Thus, the UPM 204 may utilize the ID table 205 to determine policy for a given a user and related UE.

A policy administrator 206 may provide a master policy to the UPM 204. The policy administrator 206 may be associated with an entity (e.g., a company). The policy administrator 206 may therefore be a third party server, computer, etc. that is configured to transmit data to the network provider 202. Additionally or alternatively, the policy administrator 206 may include an API, a web portal, a cloud-based service, etc. The API may be accessed by the entity to provide, modify, and/or update user policies for the entity. The API may cause the master policy 208 to be stored in the policy database 207.

Upon receiving the master policy 208, the UPM 204 may organize some or all of the policies of the master policy 208 within the policy database 207. As seen in FIG. 2A, the master policy 208 may include first and second user policies 210a-b. The first user policy 210a may be associated with a Location A and the second user policy 210b may be associated with a Location B. and include bandwidth parameters, QoS standards, access control data, and/or security control. Although not shown in FIG. 2A, the first user policy 210a and the second user policy 210b may also include other network parameters or rules (e.g., data caps, time-based rules, etc.). Furthermore, the first and second user policies 110a-b may also include associations with particular users, UEs, etc.

The UPM 204 may then store data included in the first and second user policies 110a-b in the ID table 205 and/or the policy database 207. For example, the device IDs and/or user IDs may be stored in the ID table. The master policy 208 and/or the first and second user policies 210a-b may be stored in the policy database 207. In some embodiments, the policy database 207 may include user policies for a single entity. For example, Company A may be a client of the network provider 202. The policy database 207 may then include only user policies covering users associated with Company A. In other embodiments, the policy database 207 may include policies from multiple entities at once and utilize the device IDs etc. to locate an appropriate policy within the policy database 207. In some embodiments, the ID table 205 may be a component (e.g., a row or a column) within the policy database 207.

FIG. 2B illustrates the system 200 providing network services to a UE 220, according to certain embodiments. FIG. 2C illustrates the UPM 204 of the system 200 generating first network parameters 214a, according to certain embodiments. FIGS. 2B and 2C will be described together. The UPM 204 may include a parameter generator 211. As seen in FIG. 2B, the system 200 may include a NAC 212a and an RU 223. The NAC 212a may include one or more 5G core functions, such as an AMF, SMF, PRF, etc. The NAC 212a may be configured to control some or all of the operations of the RU 223. One or more of the network functions of the NAC 212a may be configured, at least in part, based on instructions received from the UPM 204.

The UE 220 may transmit a request 222a for network services (e.g., wireless services, resource access, etc.) to the network provider 202 via the RU 223. The request 222a may include a device ID (such as a MAC address, etc.), user ID (associated with the user of the UE 220), an organizational ID (i.e., identifying Company A), and other such information. The RU 223 may then transmit some or all of the request to the NAC 212a. The NAC 212a may determine whether a policy, profile, etc. exists within the NAC 212a associated with the UE 220. If, for example, the UE 220 has been previously connected to the RU 223 and/or the NAC 212a, the NAC 212a may already “know” which policies apply to the UE 220. The NAC 212a may then provide network services to the UE 220 according to the policies.

On the other hand, if the UE 220 has never been connected to the NAC 212a, the NAC 212a may transmit some or all of the information included in the request 222a. For example, the NAC 212a may transmit just the device ID to the UPM 204. The UPM 204 may then determine and/or generate policies in response to the request.

The parameter generator 211 may include one or more software and/or hardware components configured to determine rules etc. from user policies and generate executable instructions as the first network parameters 214a, as shown in FIG. 2C. The parameter generator 211 may determine the rules and/or service levels indicated in the first user policy 210a from fields, strings, etc. provided by the policy administrator 206. For example, the first user policy 210a may indicate that the first user policy 210a is applicable at Location A. The parameter generator 211 may then determine an IP address (or other such routing means) associated with the Location A. Similarly, the parameter generator may determine a bandwidth or data rate (here, 20 Gbps) and a QoS level to be provided to the UE 220. The parameter generator 211 may then generate the network parameters 214a to include executable code according to the first user policy 210a.

Returning to FIG. B, the network parameters 214a may then be transmitted to the NAC 212a by the UPM 204. Based on the network parameters 214a, the NAC 212a may configure (or reconfigure) one or more network functions or other resources in order to provide network services to the UE 220. For example, the RU 223 and/or NAC 212a may be a 5G wireless network system (or components thereof). For example, the first user policies 210a may indicate that over a 5G wireless network at Location A, the UE 220 is to have priority voice data service, but limited data service. In another example, the first user policy 210a may indicate that a particular access control protocol is to be used. Then, before providing network services to the UE 220, the network provider 202 (via the NAC 212a and/or the RU 223) may require that the UE 220 authenticate before being provided some or all of the network services (e.g., via username/password, multifactor authentication, etc.). The network provider 202 may provide the requested network services to the UE 220 only after the appropriate access control authentication steps are met.

In another example, the network parameters 214a may indicate that the requested network services are to be provided using an appropriate security protocol. The provider 202 and/or the NAC 212a may then cause the UE 220 to be prompted to encrypt some or all of the data that is to be transmitted and/or received via the network provider 202. In response, the UE 220 may confirm that the data is encrypted and the network provider 202 may provide the requested network services.The examples provided and described here are not meant to be limiting. One of ordinary skill in the art would recognize many different possibilities and configurations.

FIG. 2D illustrates the system 200 providing network services to the UE 220, according to some embodiments. The UE 220 may be in a different location than Location A (e.g., Location B). Thus, the UE 220 may no longer be in communication with the RU 223 and/or the NAC 212a. Instead the UE 220 may attempt to connect to the network provider 202 via the NAC 212b and the RU 226. The NAC 212b may be associated with the network provider 202. Or may be associated with a partner network. For example, the network provider 202 may not have adequate wireless coverage at Location B. The network provider may then contract with a roaming partner in order to provide network services to the UE 220 (and/or other devices).

The NAC 212b and RU 226 may be a cellular data network (e.g., 5G, 4G, etc.), a Wi-Fi network (such as in a building), or any other kind of network. The request 222b may include a device ID (such as a MAC address, etc.), user ID (associated with the user of the UE 220), an organizational ID (i.e., identifying Company A), and other such information. The RU 226 may then transmit some or all of the request to the NAC 212b. The NAC 212b may determine whether a policy, profile, etc. exists within the NAC 212b associated with the UE 220. If, for example, the UE 220 has been previously connected to the RU 223 and/or the NAC 212b, the NAC 212b may already “know” which policies apply to the UE 220. The NAC 212b may then provide network services to the UE 220 according to the policies. If the UE 220 has never been connected to the NAC 212b, the NAC 212b may transmit some or all of the information included in the request 222b. For example, the NAC 212b may transmit just the device ID to the UPM 204. The UPM 204 may then determine and/or generate policies in response to the request.

The network parameters 214b may be generated by the parameter generator 211. The network parameters 214b may be the same as the network parameters 214a or may be different. For example, if the NAC 212b and RU 226 are associated with a WiFi network, different data limits, encryption protocols, access protocols etc. may be different than those for the NAC 212a. The network provider 202 may therefore configure (or reconfigure) one or more network fucntions (or other components) in order to provide network services to the UE 220.

In the case that the NAC 212b is associated with a roaming partner, the UE 220 may still be able to receive network services per any policies (e.g., the second user policy 210b). In other architectures, the policy administrator 206 may be responsible for pushing policies to all networks that the UE 220 may connect to. However, because the policy administrator 206 may utilize the network provider 202 for network services, the policy administrator 206 may not even know which roaming partners to notify of the appropriate policies. Furthermore, the policy administrator 206 may not know which NACs to provide policies for, even if all NACs are controlled by the network provider 202. Because the UPM 204 is centrally located however, and accessible to any NAC of the network provider 202, the policies may be pushed to the appropriate NAC in response to a request. This system thereby efficiently provides a uniform policy distribution across systems of the network provider 202 (and its roaming partners), allowing for improved service to the UE 220.

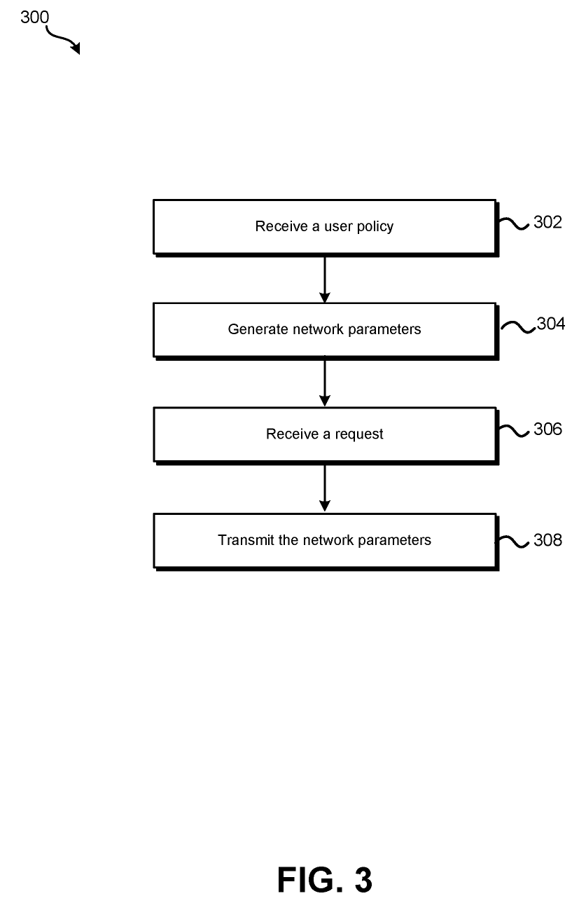

FIG. 3 illustrates a flowchart of a method 300 for providing uniform policy storage and distribution, according to certain embodiments. The method 300 may be performed by some or all of the systems described herein, such as the system 100 in FIG. 1 and/or the system 200 in FIG. 2. The steps of the method 300 may be performed in a different order than is presented here, and/or some steps may be combined with other steps. In some embodiments, some steps may be skipped altogether.

At step 302, the method 300 may include receiving, by a uniform policy module (UPM) of a network provider, a user policy for providing network services to a user device. The network provider 202 may be similar to the network provider 102 in FIG. 1. The network provider may be a wireless network provider that provider cellular service, data services, internet access, wireless access point(s), switches, routers, and or other network components. The wireless network provider may therefore include one or more physical and/or virtual computers that are configured to operate in concert in order to provide some or all of the functionality described herein. For example, the network provider may provide a 5G cellular network. The 5G cellular network may be a standalone 5G network or may be a hybrid network including 3G, 4G, 6G, and/or 7G components. Some or all of the 5G network may be implemented using a distributed, cloud-based network. The request may be a registrations request (e.g., a first time the user device has attempted to connect to the NAC).

At step 304, the method 300 may include generating, by the uniform policy module, one or more network parameters associated with the user device and based at least in part on the user policy. The UPM may parse the user policies in order to the one or more network parameters, such as is described in FIG. 2C. For example, the UPM may generate executable code to configure (or reconfigure) one or more network functions in order to provide network services to the user device. In some embodiments, the UPM may generate the network parameters upon receiving the user policies. In other embodiments, the UPM may generate the network parameters upon receiving a request from a NAC.

At step 306, the method 300 may include receiving, by the uniform policy module, a request from a network access controller associated with the network provider to provide network services to the user device. The request may be received from a NAC controlled by the network provider or may be received from a NAC controlled by a third party (e.g., a roaming partner of the network provider). The request may identify the user device, an associated organization, a user, or other such information.

At step 308, the method may include transmitting, by the uniform policy module, at least some of one or more network parameters to the network access controller, such that the network access controller provides the network services to the user device according to the transmitted network parameters such that the request is fulfilled. To do so, the network provider (i.e., the NAC) may adhere to one or more of the network parameters such as bandwidth requirements, QoS requirements, access protocols, security protocols, etc. Some or all of the network parameters may be transmitted to the roaming partner of the network provider, as appropriate.

In some embodiments, the network parameters may include access control parameters, indicating authentication and/or authorization requirements for providing network services to the user device. in response to receiving the authentication requirements, the NAC may verify that the authentication requirements are satisfied before providing network service to the user device.

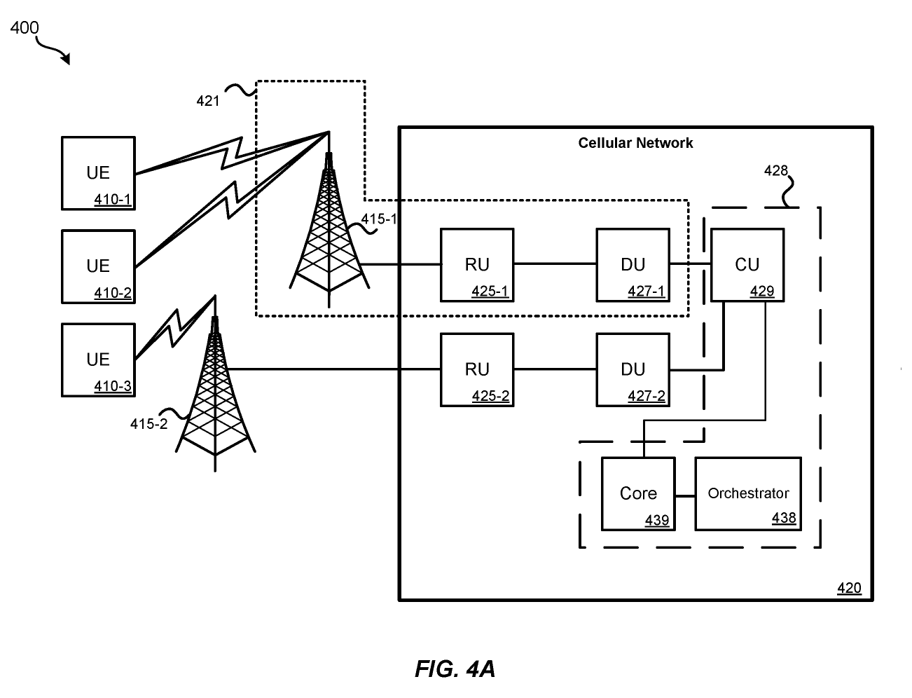

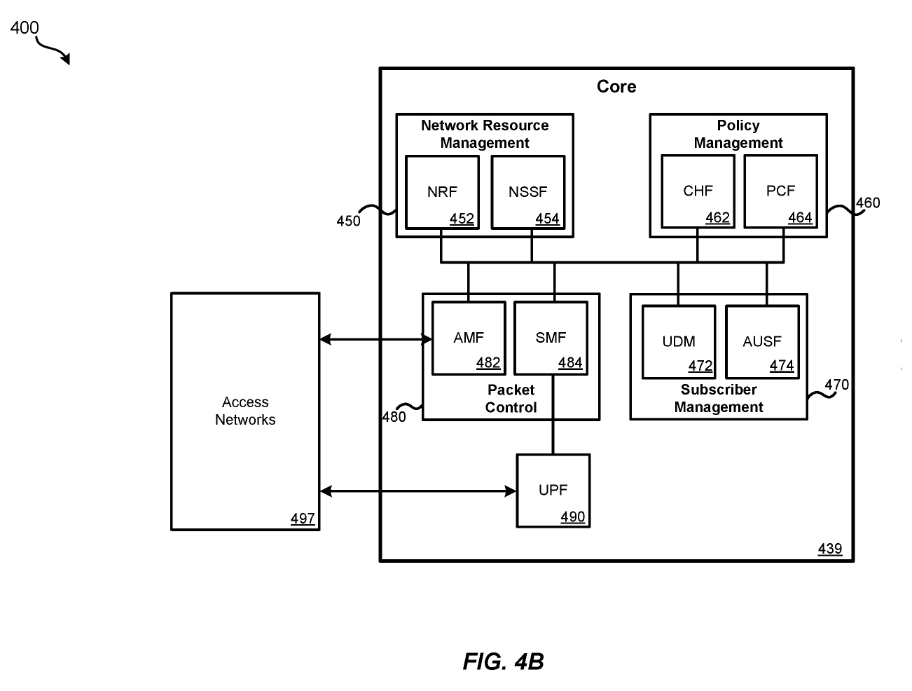

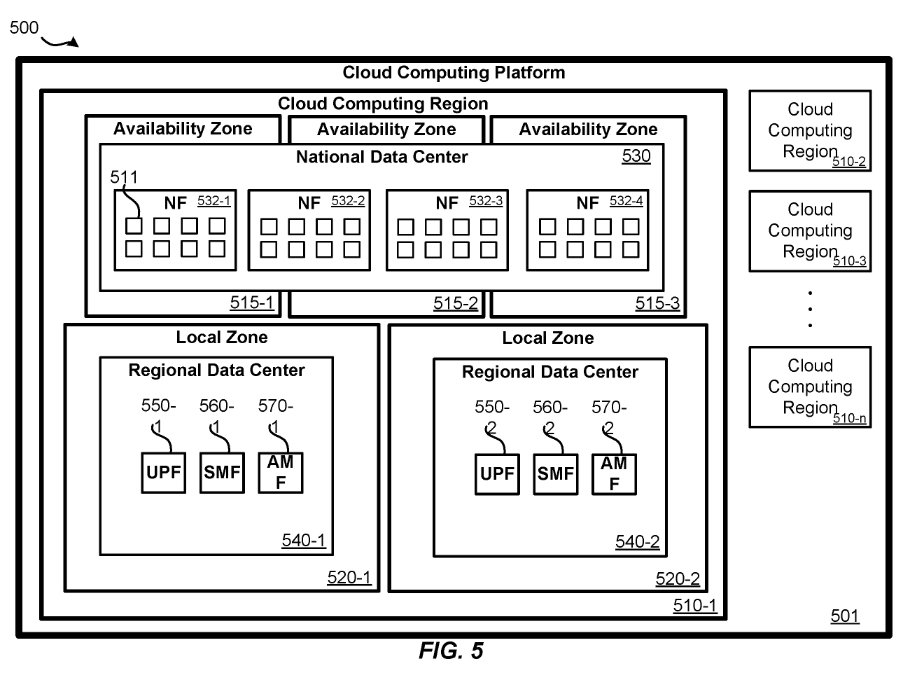

FIG. 4A illustrates an embodiment of a cellular network system 400 (“system 400”), according to certain embodiments. System 400 can include a fifth generation (5G) New Radio (NR) cellular network; other types of cellular networks, such as fourth generation (4G) long-term evolution (LTE) cellular network, sixth generation (6G) cellular network, seventh generation (7G) cellular network, etc. are also possible. System 400 can include: UE 410 (UE 410-1, UE 410-2, UE 410-3); base station 415; cellular network 420; radio units 425 (“RUs 425”); distributed units 427 (“DUs 427”); centralized unit 429 (“CU 429”); core 439, and orchestrator 438. FIG. 4A represents a component level view. In a virtualized open radio access network (O-RAN), because components can be implemented as software in the cloud, except for components that receive and transmit RF, the functionality of various components can be shifted among different servers, for which the hardware may be maintained by a separate (e.g., public) cloud-service provider, to accommodate where the functionality of such components is needed, such as detailed in relation to FIG. 5.

UE 410 can represent various types of end-user devices, such as smartphones, cellular modems, cellular-enabled computerized devices, sensor devices, manufacturing equipment, gaming devices, access points (APs), any computerized device capable of communicating via a cellular network, etc. UE can also represent any type of device that has incorporated a cellular (e.g., 5G) interface, such as a 5G modem. Examples include sensor devices, Internet of Things (IoT) devices, manufacturing robots; unmanned aerial (or land-based) vehicles, network-connected vehicles, environmental sensors, etc. UE 410 may use RF to communicate with various base stations of cellular network 420. Two base stations 415 (BS 415-1, 415-2) are illustrated. Real-world implementations of system 400 can include many (e.g., hundreds, thousands) base stations, and many RUs, DUs, and CUs. BS 415 can include one or more antennas that allow RUs 425 to communicate wirelessly with UEs 410. RUs 425 can represent an edge of cellular network 420 where data is transitioned to wireless communication. In some implementations, the radio access technology (RAT) used by RU 425 is 5G New Radio (NR). Other implementations use other RAT, such as 4G Long Term Evolution (LTE). The remainder of cellular network 420 may be based on an exclusive 5G architecture, a hybrid 4G/5G architecture, a 4G architecture, or some other cellular network architecture. Base station equipment 421 may include an RU (e.g., RU 425-1) and a DU (e.g., DU 427-1) located on site at the base station. In some embodiments, the DU may be physically remote from the RU. For instance, multiple DUs may be housed at a central location and connected to geographically distant (e.g., within a couple of kilometers) RUs.

One or more RUs, such as RU 425-1, may communicate with DU 427-1. As an example, at a possible cell site, three RUs may be present, each connected with the same DU. Different RUs may be present for different portions of the spectrum. For instance, a first RU may operate on the spectrum in the citizens broadcast radio service (CBRS) band while a second RU may operate on a separate portion of the spectrum, such as, for example, “band 71” (a radiofrequency band near 600 Megahertz allocated for cellular communications). One or more DUs, such as DU 427-1, may communicate with CU 429. Collectively, RUs, DUs, and CUs create a gNodeB, which serves as the radio access network (RAN) of cellular network 420. CU 429 can communicate with core 439. The specific architecture of cellular network 420 can vary by embodiment. Edge cloud server systems outside of cellular network 420 may communicate, either directly, via the Internet, or via some other network, with components of cellular network 420. For example, one or more DUs 427-1 may be able to communicate with an edge cloud server system without routing data through CU 429 or core 439.

At a high level, the various components of a gNodeB can be understood as follows: RUs perform RF-based communication with UE. DUs support lower layers of the protocol stack such as the radio link control (RLC) layer, the medium access control (MAC) layer, and the physical communication layer. CUs support higher layers of the protocol stack such as the service data adaptation protocol (SDAP) layer, the packet data convergence protocol (PDCP) layer and the radio resource control (RRC) layer. A single CU can provide service to multiple co-located or geographically distributed DUs. A single DU can communicate with multiple RUs.

Further detail regarding exemplary core 439 is provided in relation to FIG. 4B. FIG. 4B illustrates an exemplary core 439, according to certain embodiments. The exemplary core 439 can be physically distributed across data centers or located at a central national data center (NDC), such as detailed in relation to FIG. 5, can perform various core functions of the cellular network. Core 439 can include: network resource management components 450; policy management components 460; subscriber management components 470; and packet control components 480. Individual components may communicate via a bus, thus allowing various components of core 439 to communicate with each other directly. Core 439 is simplified to show some key components. Implementations can involve additional components.

Network resource management components 450 can include: Network Repository Function (NRF) 452 and Network Slice Selection Function (NSSF) 454. NRF 452 can allow 5G network functions (NFs) to register and discover each other via a standards-based application programming interface (API). NSSF 454 can be used by AMF 482 to assist with the selection of a network slice that will serve a particular UE (e.g., UEs 410 of FIG. 4A).

Policy management components 460 can include: Charging Function (CHF) 462 and Policy Control Function (PCF) 464. CHF 462 allows charging services to be offered to authorized network functions. Converged online and offline charging can be supported. PCF 464 allows for policy control functions and the related 5G signaling interfaces to be supported.

Subscriber management components 470 can include: Unified Data Management (UDM) 472 and Authentication Server Function (AUSF) 474. UDM 472 can allow for generation of authentication vectors, user identification handling, NF registration management, and retrieval of UE individual subscription data for slice selection. AUSF 474 performs authentication with UEs.

Packet control components 480 can include: Access and Mobility Management Function (AMF) 482 and Session Management Function (SMF) 484. AMF 482 can receive connection- and session-related information from UEs and is responsible for handling connection and mobility management tasks. SMF 484 is responsible for interacting with the decoupled data plane, creating updating and removing Protocol Data Unit (PDU) sessions, and managing session context with the User Plane Function (UPF).

User plane function (UPF) 490 can be responsible for packet routing and forwarding, packet inspection, quality of service (QoS) handling, and external PDU sessions for interconnecting with a Data Network (DN) (e.g., the Internet) or various access networks 497. Access networks 497 can include the RAN of cellular network 420 of FIG. 4A.

While FIGS. 4A and 4B illustrate various components of cellular network 420, it should be understood that other embodiments of cellular network 420 can vary the arrangement, communication paths, and specific components of cellular network 420. While RU 425 may include specialized radio access componentry to enable wireless communication with UE 410, other components of cellular network 420 may be implemented using either specialized hardware, specialized firmware, and/or specialized software executed on a general-purpose server system. In a virtualized arrangement, specialized software on general-purpose hardware may be used to perform the functions of components such as DU 427, CU 429, and core 439. Functionality of such components can be co-located or located at disparate physical server systems. For example, certain components of core 439 may be co-located with components of CU 429.

Returning to FIG. 4A, some O-RAN implementations of the DUs 427, CU 429, core 439, and/or orchestrator 438 are implemented virtually as software being executed by general-purpose computing equipment, such as in a data center. Therefore, depending on needs, the functionality of a DU, CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 400, cloud-based cellular network components A128 include CU 429, core 439, and orchestrator 438. In some embodiments, DUs 427 may be partially or fully added to cloud-based cellular network components 428. Such cloud-based cellular network components 428 may be executed as specialized software executed by underlying general-purpose computer servers. Cloud-based cellular network components 428 may be executed on a public third-party cloud-based computing platform or a cloud-based computing platform operated by the same entity that operates the RAN. A cloud-based computing platform may have the ability to devote additional hardware resources to cloud-based cellular network components 428 or implement additional instances of such components when requested. A “public” cloud-based computing platform refers to a platform where various unrelated entities can each establish an account and separately utilize the cloud computing resources, the cloud computing platform managing segregation and privacy of each entity’s data.

Kubernetes, or some other container orchestration platform, can be used to create and destroy the logical DU, CU, or 5G core units and subunits, as needed, for the cellular network 420 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions. When the need for the logical DU or subcomponents of the DU no longer exists (i.e., when traffic subsequently decreases), Kubernetes can allow for removal of the logical DU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 438. Orchestrator 438 can represent various software processes executed by underlying computer hardware. Orchestrator 438 can monitor cellular network 420 and determine the amount and location at which cellular network functions should be deployed to meet or attempt to meet service level agreements (SLAs) across slices of the cellular network.

Orchestrator 438 can allow for the instantiation of new cloud-based components of cellular network 420. As an example, to instantiate a new DU, orchestrator 438 can perform a pipeline of calling the DU code from a software repository incorporated as part of, or separate from, cellular network 420; pulling corresponding configuration files (e.g., helm charts); creating Kubernetes nodes/pods; loading DU containers; configuring the DU; and activating other support functions (e.g., Prometheus, instances/connections to test tools).

A network slice functions as a virtual network operating on cellular network 420. Cellular network 420 is shared with some number of other network slices, such as hundreds or thousands of network slices. Communication bandwidth and computing resources of the underlying physical network can be reserved for individual network slices, thus allowing the individual network slices to reliably meet particular service level agreement (SLA) levels and parameters. By controlling the location and amount of computing and communication resources allocated to a network slice, the SLA attributes for UE on the network slice can be varied on different slices. A network slice can be configured to provide sufficient resources for a particular application to be properly executed and delivered (e.g., gaming services, video services, voice services, location services, sensor reporting services, data services, etc.). However, such allocations also account for resource limitations, such as to avoid allocation of an excess of resources to any particular UE group and/or application. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 425-1 and DU 427-1; and a second set of network slices, which may only partially overlap or may be wholly different from the first set, may be reserved at RU 425-2 and DU 427-2.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

As illustrated in FIG. 4A, UE 410 may be operating on one or more production slices of cellular network 420. As detailed later in this document, a UE that functions on a particular entity’s local network may be assigned to a slice particular to the entity or a slice that provides a particular QoE for tasks to be performed by the entity’s UE.

Components such as DUs 427, CU 429, orchestrator 438, and core 439 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

FIG. 5 illustrates an embodiment of a cellular network core network topology 500 as implemented on a public cloud-computing platform, according to certain embodiments. The cellular network core network topology 500 can be an implementation of the core 439 of FIGS. 4A and/ or 4B. Cellular network core network topology 500 can represent how logical cellular network groups are distributed across cloud computing infrastructure of cloud computing platform 501. Cloud computing platform 501 can be logically and physically divided up into various different cloud computing regions 510. Each of cloud computing regions 510 can be isolated from other cloud computing regions to help provide fault tolerance, fail-over, load-balancing, and/or stability and each of cloud computing regions 510 can be composed of multiple availability zones, each of which can be a separate data center located in general proximity to each other (e.g., within 600 miles). Further, each of cloud computing regions 510 may provide superior service to a particular geographic region based on physical proximity. For example, cloud computing region 510-1 may have its datacenters and hardware located in the northeast of the United States while cloud computing region 510-2 may have its datacenters and hardware located in California. For simplicity, the details of the cellular network as executed in only cloud computing region 510-1 is illustrated. Similar components may be executed in other cloud computing regions of cloud computing regions 510 (510-2, 510-3, 510-n).

In other embodiments, cloud computing platform 501 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 510 may include multiple availability zones 515. Each of availability zones 515 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 515. For example, a database that is maintained as part of NDC 530 may be replicated across availability zones 515; therefore, if an availability zone of the cloud computing region is unavailable, a copy of the database remains up-to-date and available, thus allowing for continuous or near continuous functionality.

On a (e.g., public) cloud computing platform, cloud computing region 510-1 may include the ability to use a different type of data center or group of data centers, which can be referred to as local zones 520. For instance, a client, such as a provider of the hybrid cloud cellular network, can select from more options of the computing resources that can be reserved at an availability zone 515 compared to a local zone 520. However, a local zone 520 may provide computing resources nearby geographic locations where an availability zone 515 is not available. Therefore, to provide low latency, certain network components, such as regional data centers 540, can be implemented at local zones 520 rather than availability zones 515. In some circumstances, a geographic region can have both a local zone 520 and an availability zone 515.

In the topology of a 5G NR cellular network, 5G core functions of core 439 can logically reside as part of a national data center (NDC) 530. NDC 530 can be understood as having its functionality existing in cloud computing region 510-1 across multiple availability zones 515. At NDC 530, various network functions, such as NFs 532, are executed. For illustrative purposes, each NF 532, whether at NDC 530 or elsewhere located, can be comprised of multiple sub-components, referred to as pods (e.g., pod 511) that are each executed as a separate process by the cloud computing region 510. The illustrated number of pods 511 is merely an example; fewer or greater numbers of pods 511 may be part of the respective 5G core functions. It should be understood that in a real-world implementation, a cellular network core, whether for 5G or some other standard, can include many more network functions. By distributing NFs 532 across availability zones 515, load-balancing, redundancy, and fail-over can be achieved. In local zones 520, multiple regional data centers 540 can be logically present. Each of regional data centers 540 may execute 5G core functions for a different geographic region or group of RAN components. As an example, 5G core components that can be executed within an RDC, such as RDC 540-1, may be: UPFs 550, SMFs 560, and AMFs 570. While instances of UPFs 550 and SMFs 560 may be executed in local zones 520, SMFs 560 may be executed across multiple local zones 520 for redundancy, processing load-balancing, and fail-over.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method of providing network services by a network provider, comprising:
receiving, by a uniform policy module of a network provider, a user policy for providing network services to a user device;
generating, by the uniform policy module, one or more network parameters associated with the user device and based at least in part on the user policy;
receiving, by the uniform policy module, a request from a network access controller associated with the network provider to provide network services to the user device; and
transmitting, by the uniform policy module, at least some of one or more network parameters to the network access controller, such that the network access controller provides the network services to the user device according to the transmitted network parameters such that the request is fulfilled.

2. The method of providing network services of claim 1, wherein:
the one or more network parameters include a bandwidth allocation indicating an amount of bandwidth allocated to the user device.

3. The method of providing network services of claim 1, wherein:
the one or more network parameters include quality of service (QoS) parameters indicating priority levels for different types of traffic transmitted to and from the user device.

4. The method of providing network services of claim 1, wherein:
the one or more network parameters include access control parameters indicating authentication requirements for providing the network services to the user device; and
in response to receiving the access control parameters, the network access controller verifies that the authentication requirements are satisfied before providing the network services to the user device.

5. The method of providing network services of claim 1, wherein:
the one or more network parameters include security parameters indicating encryption protocols and security measures to be applied to data transmitted to and from the user device.

6. The method of providing network services of claim 1, wherein:
the uniform policy module is accessible by a plurality of network access controllers.

7. The method of providing network services of claim 1, wherein:
the request to provide network services to the user device is generated by the network access controller in response to receiving a registration request from the user device via an access point managed by the network access controller.

8. The method of providing network services of claim 1, wherein a first set of the one or more network parameters is associated with a first location, and a second set of the one or more network parameters are associated with a second location.

9. The method of providing network services of claim 1, wherein the user policy and/or the one or more network parameters are stored in a policy database.

10. A system for providing network services, comprising:
one or more processors; and
a computer readable memory comprising instructions that, when executed by the one or more processors, cause the one or more processors to perform operations to:
receive, by a uniform policy module of a network provider, a user policy comprising one or more rules for providing network services to a user;
generating, by the uniform policy module, one or more network parameters associated with a user device based at least in part on the user policy;
receiving, by the uniform policy module, a request from a network access controller associated with the provide network services to the user device associated with the user; and
transmitting, by the uniform policy module, at least some of one or more network parameters to the network access controller, such that the network access controller provides the network services to the user device associated with the user according to the transmitted network parameters.

11. The system of claim 10, wherein the uniform policy module comprises one or more user policies, each associated with a respective user.

12. The system of claim 10, wherein the user policy comprises a first set of rules associated with a first user device associated with the user and a second set of rules associated with a second user device associated with the user.

13. The system of claim 10, wherein:
the one or more network parameters include a bandwidth allocation indicating an amount of bandwidth allocated to the user device.

14. The system of claim 10, wherein:
the one or more network configuration parameters include quality of service (QoS) parameters indicating priority levels for different types of traffic transmitted to and from the user device.

15. The system of claim 10, wherein:
the one or more network configuration parameters include access control parameters indicating authentication and authorization requirements for providing the network services to the user device; and
in response to receiving the access control parameters, the network access controller verifies that the authentication and authorization requirements are satisfied before providing the network services to the user device.

16. A non-transitory computer-readable memory comprising instructions that, when executed by one or more processors, cause the one or more processors to perform operations comprising:
receiving, by a uniform policy module of a network provider, a user policy for providing network services to a user device;
generating, by the uniform policy module, one or more network parameters associated with the user device and based at least in part on the user policy;
receiving, by the uniform policy module, a request from a network access controller associated with the network provider to provide network services to the user device; and
transmitting, by the uniform policy module, at least some of one or more network parameters to the network access controller, such that the network access controller provides the network services to the user device according to the transmitted network parameters.

17. The non-transitory computer-readable memory of claim 16, wherein:
the one or more network parameters include a bandwidth allocation indicating an amount of bandwidth allocated to the user device.

18. The non-transitory computer-readable memory of claim 16, wherein:
the one or more network parameters include quality of service (QoS) parameters indicating priority levels for different types of traffic transmitted to and from the user device.

19. The non-transitory computer-readable memory of claim 16, wherein:
the one or more network parameters include access control parameters indicating authentication and authorization requirements for providing the network services to the user device; and
in response to receiving the access control parameters, the network access controller verifies that the authentication and authorization requirements are satisfied before providing the network services to the user device.

20. The non-transitory computer-readable memory of claim 16, wherein:
the one or more network parameters include security parameters indicating encryption protocols and security measures to be applied to data transmitted to and from the user device.
